(19) United States
(12) Patent Application Publication
(10) Pub. No.: US 2002/0013764 A1
(43) Pub. Date: Jan. 31, 2002

(54) Method and system for validating electronic transactions

(76) Inventor: Juha-Petri Karna, Espoo (FI)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 09/828,899

(22) Filed: Apr. 10, 2001

(30) Foreign Application Priority Data
Apr. 11, 2000 (AU) PQ6828

(51) Int. Cl. G06F 17/60; G06F 15/16

(52) U.S. Cl. 705/39; 709/203

(57) ABSTRACT

In a financial transaction validation system having target servers adapted to process at least one transaction record, a method of routing a transaction record requiring validation processing originating from a source and being forwarded electronically to a validation station to validate the financial transaction is disclosed. The method includes assigning to the transaction record an identifier having an address of the target validation server.

### FIELD OF INVENTION

The present invention relates to the field of electronic transactions, particularly financial transactions, such as, but not exclusively, those made over the Internet. In one form, the invention relates to a method and/or system for processing financial transactions made via the Internet.

### BACKGROUND ART

Electronic messaging systems of various types have come into increasing use recently, mainly because of the increasing use of the Internet and access to the Internet by a relatively large portion of the population.

The issue of enabling financial transactions, particularly over the Internet has also become a service required by a relatively large number of people. In order to enhance the use of financial transactions over the Internet, it is desirable to offer an environment which is considered secure. Traditionally, several ways of providing security have been implemented. In one case, which is used in electronic funds transfer, all terminals are uniquely identified, and session keys are generated for each transaction using real time on-line links between terminal and host. This is not considered appropriate for use with Internet transactions.

Irrespective of the way in which communication regarding the financial transaction is established, there is still considered to be a need for on-line validation of electronic money. One purpose for enabling on-line validation is to avoid interference or duplication of financial transactions by unauthorised parties. Such interference or duplication by unauthorised parties may result in a fraud upon the customer and/or the financial institution and/or the vendor. In other words, the unauthorised party may appropriate a financial consideration that it is not entitled to.

One way a financial institution, such as a bank, can keep track of each financial transaction related to it or it's customers for the purpose of validation is by using a unique serial number associated with each transaction. This is somewhat akin to the serial numbers used on physical currency, such as paper notes. The validation of these transactions, must be done in order to complete the transaction, such as exchanging money from a customer's account to a vendor's account as a result of the purchase of goods or services.

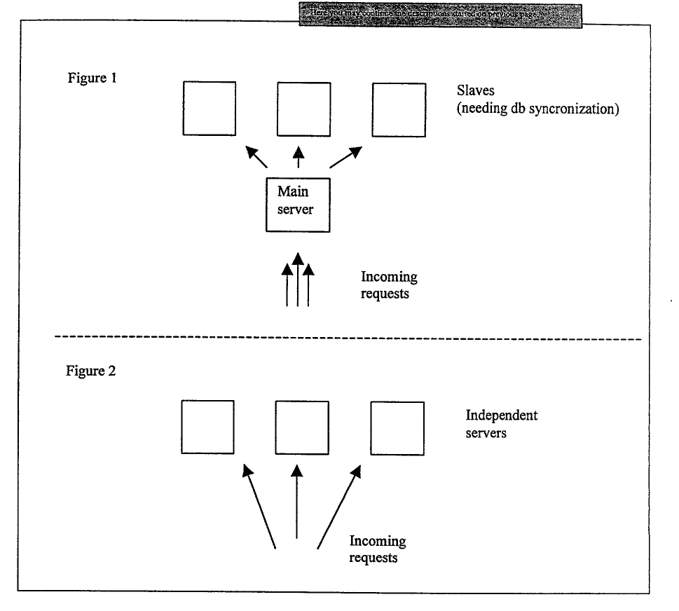

In forwarding the transactions to the financial institution for validation a problem exists with the server environment used by many financial institutions. FIG. 1 illustrates such a server environment. A main server acts as a central receiving point to receive a number of transaction records. The main server then enables the records to be forwarded to one of a plurality of slave servers. The validation process occurs at or nearer the slave servers, rather than the main server.

A problem stems from the situation where the main server of the financial institution becomes overloaded, that is the main server has a difficulty forwarding all incoming transactions to the slaves, or the main server experiences a breakdown or technical difficulties. It is considered possible for unauthorised parties to interfere with the incoming transaction traffic as a result of the overloading, breakdown or technical difficulties, the outcome of which is may be unauthorised tampering or duplication of financial transactions. Also, if the main server does breakdown, the process of validating financial transaction traffic is suspended until the main server is repaired or replaced. This can have enormous financial implications on all parties.

In the server environment illustrated in FIG. 1, there is also another problem. Because the main server distributes the transaction records for validation to any one of a number of slave servers, each slave server must be updated with information, such as transaction records from other slave servers, to ensure that the slave servers do not allow duplication of validation. In other words, without the slaves being synchronised or updated continuously, it is possible to have the situation where an authentic transaction record is validated by a first slave server and a fraudulent record is validated by a second slave server, in the absence of correlation or verification between first and second slave servers. The updating and correlation of slave servers presents a further problem in respect of timing and processing requirements.

There therefore exists a need for validation of each transaction record to be done so that it is considered extremely difficult, if not impossible, for an unauthorised party to duplicate the financial transaction or record and to provide validation in a manner that is considered relatively easier to do.

It is an object of the present invention to alleviate at least one problem of the prior art.

### SUMMARY OF INVENTION

The present invention provides a method of routing a transaction record made in respect of a financial transaction, the transaction record requiring validation processing to validate the financial transaction, the transaction record originating from a source and being forwarded electronically to a validation station,

the method including the step of:

assigning to the transaction record, an identifier identifying a target validation server, the identifier having, at least as a part thereof, an address of the target validation server.

Preferably, the target server is located at the validation station.

The present invention also provides, in a financial transaction validation system, having a plurality of target servers adapted to process at least one transaction record made in respect of a financial transaction for the purpose of validating the transaction or transaction record, the improvement including:

providing in association with each transaction record, an identifier which servers to route the record to a target server.

Preferably, the identifier includes the address of one of the plurality of target servers, such as the ip-address of the target server. Furthermore, preferably, the identifier is provided in combination with or addition to a transaction identifier, such a transaction serial number. Still further, preferably, the identifier can be provided as a or in a separating key. Also, preferably, the Identifier can be of varying length of numbers or letters (or just raw bits).

In essence, the present invention stems from the realisation that in assigning an identifier, such as any form of indicia or information which assists in identifying a target server, a transaction record can be forwarded directly to the target server, thus alleviating either the requirement to route via a main server or the possibility of overloading a main server. Assigning an identifier which can determine a target server also alleviates the need to correlate validation processing between a number of servers because the transaction record will be forwarded only to the target server identified by the identifier. Normally, slave servers need to be update with information from other servers in case the record requiring validation is sent. That is, normally, the record is server in-specific, and thus each slave server requires updating to avoid duplication or in-correct validation. Because the records in this invention are now server specific, other servers do not need to be updated with other server information. In other words, if a unauthorised or duplicated record is sent for validation, it too will have to identify a target server, and thus the duplicated record will be sent to the same target server as the true authentic record providing the opportunity for the one server to determine that one of the records sent is not authentic. If the otherwise duplicate or fraudulent record does not have the same target server address, it can really be considered to be a different record.

By the term ‘identifier’, we mean one or more identifiers. An identifier can be any form of indicia, symbol, information or means of providing some form of identification, whether attached, embedded, or associated with the record or transaction process.

By the term ‘financial institution’ we mean bank, vendor or any entity which is either a source of the transaction record and/or the processor of the record.

A preferred embodiment of the present invention will now be described with reference to the accompanying drawings, in which:

FIG. 1 illustrates a prior art validation system, and

FIG. 2 illustrates, schematically, a validation system in accordance with the prsent invention.

Referring to FIG. 2, and in comparing FIGS. 1 and 2, it can be seen that each incoming request, which represents a financial transaction requiring validation, is received directly to a target server. This results from the identifier associated with the transaction record including the target server's ip-address or other information or indicia which enables the target server to be located and/or identified.

An example identifier can consist of two parts: the ip address and a serial number. The ip address could be in the IP v4 case four octects (32 bits) and a serial number, long enough to contain different number for each electronic coin or transaction. In the IP v6 case, the address would be 16 octects (128 bits). The identifier can also contain another type of network address, for example a telephone number.

The address can be encoded in the identifier so that the actual address is computed from the identifier using a predefined algorithm by the payment software.

In the embodiment shown in FIG. 2, distribution of the financial records requiring validation, designated ‘incoming requests’, such as electronic money, is done directly to target or independent servers using the identifier or serial number as a separating key. The serial number contains the network address (ip-address) of the validation server that should be used. It may also include other information as necessary. The bank or financial institution issuing the money can choose the numbers so that the validation will be distributed among its validation servers, each server handling a range of serial numbers. In this way the validation request can travel directly to the correct server alleviating the need for or at least alleviating a central or main server becoming a bottleneck as shown in the prior art configuration of FIG. 1.

A further advantage of providing an identifier in association with a financial transaction is that updating or correlation between target server's or their associated databases is not necessary because the transaction will be forwarded only to the server the identifier addresses. Thus the required validation database can be split to several independent databases, if desired. Updating or correlation with a main system or record depository can be done at a later time, or from time to time as is necessary, but it does not need to be done continuously as with the prior art system.

1. A method of routing a transaction record made in respect of a financial transaction, the transaction record requiring validation processing to validate the financial transaction, the transaction record originating from a source and being forwarded electronically to a validation station,
the method including the step of:
assigning to the transaction record, an identifier identifying a target validation server, the identifier having, at least as a part thereof, an address of the target validation server.

2. A method as claimed in claim 1, wherein routing of the record is enabled direct to the target server.

3. In a financial transaction validation system, having a plurality of target servers adapted to process at least one transaction record made in respect of a financial transaction for the purpose of validating the transaction or transaction record, the improvement including:
providing in association with each transaction record, an identifier which servers to route the record to a target server.

4. An improvement as claimed in claim 3, in which the target server is located at a validation station.

5. An improvement as claimed in claim 3 or 4, in which the identifier includes a network address of one of the plurality of target servers.

6. An improvement as claimed in claim 5, in which the identifier includes the ip-address of the target server.

7. An improvement as claimed in any one of claims 3 to 6, in which the identifier is provided in combination with or addition to a transaction identifier, such a transaction serial number.

8. An improvement as claimed in any one of claims 3 to 7, in which the identifier can be provided as a or in a separating key.

9. An improvement as claimed in any one of claims 3 to 8, in which the identifier can be any form of indicia, symbol, information or means of providing some form of identification, whether attached, embedded, or associated with the record or transaction process.

10. An improvement as claimed in any one of claims 3 to 9, in which the financial institution we mean bank, vendor or any entity which is either a source of the transaction record and/or the processor of the record.

11. An improvement as claimed in any one of claims 3 to 9, wherein the identifier is a telephone number.

12. A financial transaction validation system including the improvement as claimed in any one of claims 3 to 11.

13. A method, improvement or system as herein disclosed.
